(19) United States
(12) Patent Application Publication
(10) Pub. No.: US 2011/0153177 A1
(43) Pub. Date: Jun. 23, 2011

(54) METHOD AND DEVICE FOR DETERMINING AND BALANCING THE WORKING POINT OF VALVES IN A HYDRAULIC SYSTEM

(76) Inventor: Ulrich Mahlenbrey, Asperg (DE)

(21) Appl. No.: 13/054,365

(22) PCT Filed: Jun. 30, 2009
(86) PCT No.: PCT/EP2009/058163

§ 371 Date: Mar. 11, 2011

(30) Foreign Application Priority Data
Jul. 18, 2008 (DE) 10 2008 040 534.5

(51) Int. Cl. B60T 8/26; F16K 31/00

(52) U.S. Cl. 701/70; 137/12; 137/485

(57) ABSTRACT

A method and an apparatus for ascertaining the working point of switchover valves of a hydraulic system of a vehicle, in particular of a hydraulic brake circuit, are described in which the hydraulic system contains at least a pressure generating arrangement, a high-pressure switching valve, a switchover valve, and an admission pressure sensor, an admission pressure that is higher than the target pressure of the switchover valve being established, the switchover valve being energized with a target current corresponding to the target pressure, admission pressure being reduced until the switchover valve closes, with the switchover valve closed, a nominal admission pressure being established as an admission pressure, after the switchover valve opens, a pressure difference Δp between admission pressure and a circuit pressure being sensed, and on the basis of the pressure difference Δp, the working point being ascertained.

### FIELD OF THE INVENTION

The present invention relates to a method for ascertaining and equalizing the working point of switchover valves or circuit pressure valves in a hydraulic system, and to a control unit for carrying out such a method. The present invention further relates to a program for execution by a data processing system that carries out the method, and to a data medium having the stored program for execution by a data processing system.

### BACKGROUND INFORMATION

Increasing numbers of vehicles are being equipped with additional active and passive safety systems, not prescribed by legislation, in order on the one hand to prevent accidents and on the other hand to minimize the consequences of accidents. Such safety systems include, for example, an electronic stability program (ESP) in which, by controlled braking interventions at the wheels of a vehicle, unintentional understeer or oversteer, and therefore vehicle breakaway, are counteracted. In addition to this standard ESP function, the dynamic wheel torque by brake (DWT-B) and lane departure prevention (LDP) functions can be integrated. With DWT-B, when rapid steering inputs are made in curves, engine torque is raised and at the same time the rear-axle wheel on the inside of the curve is lightly braked, with the result that more engine driving force is transferred to the wheel on the outside of the curve. LDP uses the vehicle stability system to assist the driver in maintaining lane position by applying slight brake pressures.

The accuracy of the brake pressures to be applied depends, in this context, on the pressure adjustment accuracy of the circuit pressures in ESP units. In a conventional ESP system, each of the brake circuits is capable, independently of the other brake circuit, of actively building up its own circuit pressure and retaining and holding pressure in the circuit. The accuracy achievable, with respect to the reference pressure request, depends principally on the tolerances of the switchover valves or circuit pressure valves (SOVs) or their tolerance zone. The brake circuits can exhibit considerable differences from one another.

The reference current flow I, calculated by the control system software, to the individual switchover valves depends on the differential pressure dp at the valve and on the volumetric flow q flowing through the valve. In the existing art, the I-dp-q characteristics diagram, which describes these correlations, is employed to calculate the control application current. The switchover valves have differing'I-dp-q characteristics diagrams as a result of production tolerances. At present only one characteristics diagram is stored in the control system software for all the valves. This is an exact fit only for a nominal valve, and does not in any way take into account tolerances.

These tolerances of the switchover valves can cause two things during operation:
(a) the absolute value of the reference pressure request is not set with sufficient accuracy; and/or
(b) despite identical control application to the two switchover valves, the circuit pressures or wheel pressures reached in the respective circuits are different.

This is very important especially when the brake circuits are split in X-fashion, i.e. one brake circuit controls the left front and right rear wheels, and the other brake circuit controls the right front and left rear wheels. With an X-split, different behavior by the two brake circuits can result in critical situations in terms of vehicle dynamics. The above-described braking interventions request specific braking torques, with the goal of influencing the vehicle's yaw behavior. In contrast to the vehicle controller, these functions are embodied purely as actuating functions, i.e. there is no controlled system with feedback.

In the case of DWT-B, for example, if the right rear wheel is braked in a right-hand curve, this deliberately causes an oversteer tendency in the vehicle's behavior. If too much pressure is then established because of the random tolerance of the switchover valve in this circuit, the vehicle will tend to become unstable and the vehicle controller has to intervene. In addition, the difference in tolerance zones between the two switchover valves is disadvantageous because the vehicle will behave differently (in a manner not comprehensible by the driver), in right-hand curves than in left-hand curves. If a function specifically wants to apply a yaw torque by way of a braking intervention on only one side of the vehicle (e.g. LDP), different tolerances in the switchover valves can once again result in a different vehicle reaction depending on which side of the vehicle is braked.

### SUMMARY OF THE INVENTION

The method according to the present invention having the features described herein encompasses, advantageously, a method for ascertaining the working point of switchover valves of a hydraulic system of a vehicle, in particular of a hydraulic brake circuit, the hydraulic system containing at least a pressure generating arrangement, a high-pressure switching valve, a switchover valve, and an admission pressure sensor.

According to the exemplary embodiments and/or exemplary embodiments of the present invention, the valves used are continuously adjustable valves, so-called switchover valves or circuit pressure valves.

The working point can be ascertained in this context in that an admission pressure p_adm that is higher than the target pressure of the switchover valve is established; the switchover valve is energized with a target current corresponding to the target pressure; admission pressure p_adm is reduced until the switchover valve closes; with the switchover valve closed, an admission pressure p_adm_nominal is established; after the switchover valve opens, a pressure difference Δp between admission pressure padmnominal and a circuit pressure p_circuit is sensed; and/or on the basis of pressure difference Δp, the working point is ascertained and/or equalized.

In ESP systems, it is possible with the method according to the present invention, using the admission pressure sensor (MC sensor) that is already present, to carry out a determination of the tolerance zones of the switchover valves for the operating state q=0 (volumetric flow=0). By subsequent adaptation or correction of the valve-specific parameters from the I-dp-q characteristics diagrams, a specific reference current stipulation for the particular switchover valves is possible. The result is that the accuracy of the absolute pressure setting in each brake circuit is increased, and the deviation between the two brake circuits is decreased.

Advantageous embodiments and refinements of the invention are made possible by the features indicated in the dependent claims.

In an exemplifying embodiment, the working point is ascertained by the fact that the admission pressure p_adm_new, that is to be established instead of admission pressure p_adm_nominal, is determined on the basis of pressure difference Δp.

According to the exemplary embodiments and/or exemplary embodiments of the present invention, when a previously set threshold value of pressure difference Δp is exceeded, admission pressure p_adm_new is increased, and/or when pressure difference Δp falls below a previously set threshold value, admission pressure p_adm_new is decreased.

It is likewise possible for the target pressure to be determined in accordance with the I-dp-q characteristics diagram.

In an advantageous embodiment, the reduction of admission pressure p_adm can be accomplished with a constant gradient.

According to the exemplary embodiments and/or exemplary embodiments of the present invention, a nominal characteristics diagram can be adapted by way of the ascertained admission pressure p_adm_new, with the result that a separate characteristics diagram does not need to be stored for each switchover valve.

The admission pressure may be regulated by way of the brake pedal in the context of the switchover valve equalizing operation. It is necessary for this purpose to make the measured admission pressure available via the diagnostic interface. The average of multiple measurements may be used for the characteristics diagram correction. An offset correction and/or a rotation of the relevant characteristic curves is advisable in this context. The measurements may make possible a conclusion as to the actuating behavior of the switchover valves at a volumetric flow equal to 0 (q=0). The correlation for volumetric flows greater than zero depends on the behavior at q=0.

All the switchover valves in a circuit can be measured in one measurement run, so that a time saving as compared with individual measurements can be achieved. The correction value ascertained in the previous measurements can be taken into account in the repeat measurements, and utilized to calculate the new starting value. Approximation of the admission pressure to the circuit pressure may be accomplished in steps, by iteration. The step size can be adjusted in accordance with an accuracy that is to be determined. “Adaptation” can be understood for purposes of the invention as an increase and/or a decrease.

If the pressure sensor is mounted on one circuit, the friction of the main cylinder piston should be taken into account for calculating the pressure in the other circuit. The inlet valve or valves of the lower-pressure circuit (i.e. the circuit that is measured first) may close before the switchover valve of the higher-pressure circuit opens, so that the circuit volume does not reduce the pressure rise in the circuit that is to be measured.

The method moreover exhibits the further advantages that no additional external sensors are required. The performance of non-regulating functions, for example DWT-B, LDP, BDW, especially in the case of an X-type brake circuit split, and of regulating functions such as FZR, ASR, CDD, is furthermore improved by way of the method according to the present invention.

In addition, because of the more accurate over-energization of the closed valve, the power dissipation that occurs, and the increase in temperature resulting therefrom, can be decreased. Greater tolerances in valve manufacture are also possible because the tolerance of the switchover valves is compensated for during operation.

A further aspect of the invention relates to an apparatus for ascertaining the working point of switchover valves of a hydraulic system of a vehicle, in particular of a hydraulic brake circuit, the hydraulic system containing at least a pressure generating arrangement, a high-pressure switching valve, a switchover valve, and an admission pressure sensor.

Yet another further aspect of the invention relates to a program for execution by a data processing system, the program carrying out the steps of the method according to the present invention upon execution in a computer or in a control unit.

The exemplary embodiments and/or exemplary embodiments of the present invention further relates to a data medium, a program for carrying out the method according to the present invention being stored on the data medium.

The exemplary embodiments and/or exemplary embodiments of the present invention is further explained by way of example below, with reference to the appended drawings.

### BRIEF DESCRIPTION OF THE DRAWINGS

FIG. 1 is a block diagram of a hydraulic brake system of a vehicle.

FIG. 2 shows a sequence over time for determination of the holding pressure.

FIG. 3 is a flow chart illustrating equalization of the characteristic diagrams.

FIG. 4 is a block diagram of a circuit assemblage.

### DETAILED DESCRIPTION

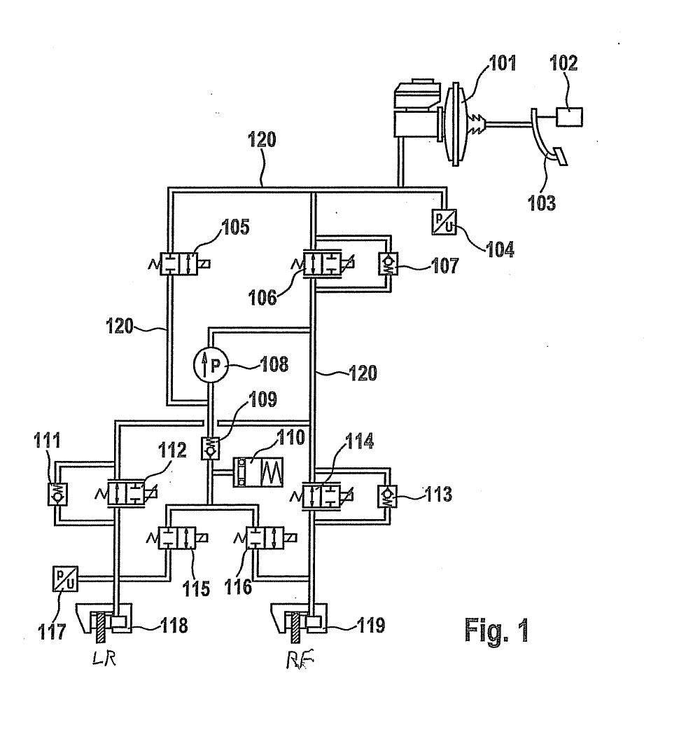

FIG. 1 is a block diagram of a hydraulic brake system of a vehicle in which the hydraulic brake system is split in known fashion into two circuits, only the first circuit being depicted here. The circuit serves to actuate the brakes of the left rear wheel LR and right front wheel RF of the vehicle. In the present case, a vehicle having four wheels is assumed. If more than four wheels are present, they either can be referred to the double-circuit braking system as illustrated in FIG. 1, or more than two independent brake circuits can be present. The hydraulic system is connected to a double-circuit main brake cylinder 101 that encompasses one or two independent master cylinders that can be actuated by a brake pedal 103. Brake pedal 103 additionally applies control to a brake light switch 102. The mutually independent brake cylinders are described below using the example of the first brake circuit, the second brake cylinder being of identical construction.

The first brake cylinder of the hydraulic brake circuit has wheel brake cylinders 118 and 119 that are respectively mounted, in operational fashion, on wheels LR and RF of the vehicle. Main brake cylinder 101 is connected, via a hydraulic line 120 on which a main-brake-cylinder-side pressure sensor 104 is disposed, to a high-pressure switching valve 105. High-pressure switching valve 105 is closed in the unenergized state, and opens upon energization. This can be a meterable valve (a so-called proportional valve) that can be brought into any positions between the opened and closed position; or a switching valve having only an open and a closed position. High-pressure switching valve 105 is connected to the intake side of a hydraulic pump 108. The delivery side of hydraulic pump 108 is connected via a valve 112 to wheel brake cylinder 118, and via a valve 114 to wheel brake cylinder 119. Valves 112 and 114 are open in the unenergized state, and are respectively bypassed by check valves 112, 113 that enable reverse flow out of wheel brake cylinders 118 and 119. Wheel brake cylinder 118 is connected via a valve 115, wheel brake cylinder 119 via a valve 116, and the two together via a check valve 109, to the intake side of hydraulic pump 108. Valves 115 and 116 are closed in the unenergized state. A pressure reservoir 110 is disposed on the side of check valve 109 facing toward valves 115 and 116. A wheel-brake-cylinder-side pressure sensor 117 is disposed on wheel brake cylinder 118. A switchover valve 106 allows disconnection of the high-pressure side of hydraulic pump 108 from main brake cylinder 101. Switchover valve 106 is bypassed by a check valve 107 that opens in the direction of the wheel brake cylinders.

As mentioned above, the second hydraulic circuit is identical in construction to the first hydraulic circuit, and encompasses wheel brake cylinders for the right rear wheel and for the left front wheel, with a corresponding hydraulic pump, control valves, high-pressure valves, and switchover valves.

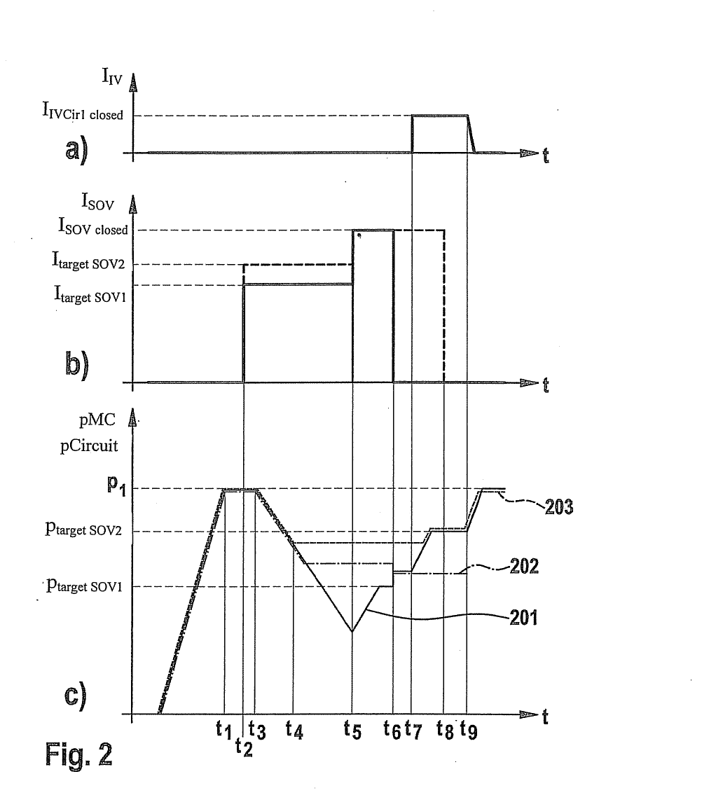

FIG. 2 depicts a sequence over time for determining the holding pressure for two switchover valves. FIG. 2a shows the curve for energization of the inlet valves for circuit 1, FIG. 2b the curve for energization of switchover valves 106 and SOV2, and FIG. 2c the pressure profile in the main cylinder. (pMC or p_adm) and in the circuit (p_circuit). In FIG. 2b, reference character 201 designates the pressure profile in the main cylinder (pMC or p_adm), reference character 202 the pressure profile in circuit 1 (p_circuit1), and reference character 203 the pressure profile in circuit 2 (p_circuit2). At time t1, a pressure that is greater than the five-sigma tolerance of the target pressure of the switchover valve of the second circuit is established using brake pedal 103. At time t2, switchover valves 106 and SOV2 are energized to a target current corresponding to the dp reference value of the I-dp-q characteristics diagram for q=0, the distance between the reference currents being greater than twice the five-sigma tolerance. At time t3 the admission pressure is decreased, with a constant gradient, to well below the five-sigma limit of switchover valves 106 and SOV2, so that both switchover valves are definitely closed. At time t4, firstly switchover valve SOV2 and then switchover valve 106 are closed, in which context both switchover valves hold pressures corresponding to their tolerance. At time t5 the nominal target pressure of switchover valve 106 is established via brake pedal 103, and both switchover valves are over-energized so that both switchover valves definitely hold their pressures. At time t6 the energization of switchover valve 106 is reduced to zero, with the result that a pressure equalization takes place between admission pressure p_adm and the first circuit. If admission pressure p_adm rises in this context, switchover valve 106 is holding a higher pressure than a standard valve. If admission pressure p_adm does not change, too low a pressure was held by switchover valve 106. At time t7, the inlet valves in the first circuit are closed in order to minimize the volume to be displaced. The potential pressure rise thereby becomes greater. At time t8 the energization of switchover valve SOV2 is reduced to zero, with the result that a pressure equalization takes place between admission pressure p_adm and the second circuit. If admission pressure p_adm remains the same in this context, switchover valve SOV2 is holding a lower pressure than a standard valve. At time t9 the inlet valves of the first circuit are opened, and pressure establishment for the subsequent measurement begins.

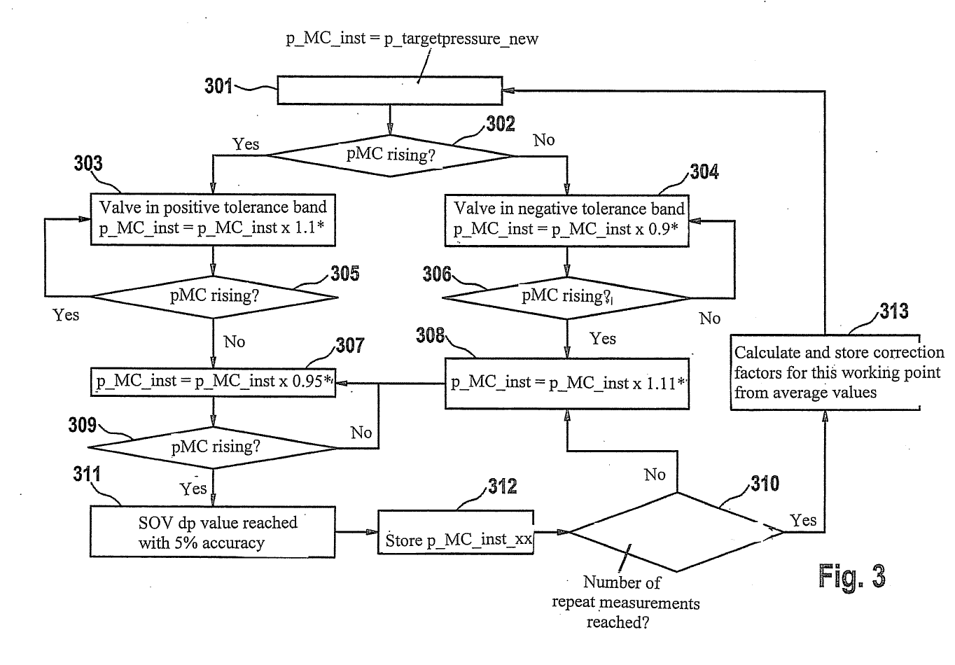

FIG. 3 is a schematic flow chart illustrating equalization of the characteristics diagrams. After initialization, the instantaneous admission pressure p_adm is present in step 301. After opening of the switchover valve, step 302 decides whether admission pressure p_adm is rising (see FIG. 2, t6 and t8). If the admission pressure is rising, the valve is in the positive tolerance band, and in step 303 admission pressure p_adm is recalculated as p_adm_inst=p_adm_inst*1.1. The next step 305 decides whether admission pressure p_adm is rising. If so, the method goes back to step 303 and admission pressure p_adm is recalculated as p_adm_inst=p_adm_inst* 1.1. If step 305 decides that admission pressure p_adm is not rising, the method continues in step 307. In step 307, admission pressure p_adm is recalculated as p_adminst=p_adminst*0.95. The next step 309 decides whether admission pressure p_adm is rising. If not, the method returns to step 307, and admission pressure p_adm is recalculated as p_adminst=p_adm_inst*0.95. If, however, step 309 decides that admission pressure p_adm is rising, the value is determined with 5% accuracy in step 311, and in step 312 is stored as the instantaneous admission pressure p_adm_inst. If the admission pressure is not rising, the valve is in the negative tolerance band, and in step 304 admission pressure p_adm is recalculated as p_adminst=p_adm_inst*0.9. The next step 306 decides whether admission pressure p_adm is rising. If that is not the case; the method returns to step 304; and admission pressure p_adm is recalculated as p_adm_inst=p_adm_inst*0.9. If step 306 decides that admission pressure p_adm is rising, the method continues in step 308. In step 308, admission pressure p_adm is recalculated as p_adminst=p_adminst*1.11. In the next step 307, admission pressure p_adm is recalculated as p_adminst=p_adminst*1.11. If, on the other hand, step 309 decides that admission pressure p_adm is rising, the value is determined with 5% accuracy in step 311 and in step 312 is stored as the instantaneous admission pressure p_adm_inst. Step 310 decides whether the previously set number of repeat measurements has been reached. If this number has not been reached, the method continues in step 308. If the number has been reached, the method continues in step 313, where correction factors for the characteristics diagram for the ascertained working point are calculated and stored. The method then returns to step 301.

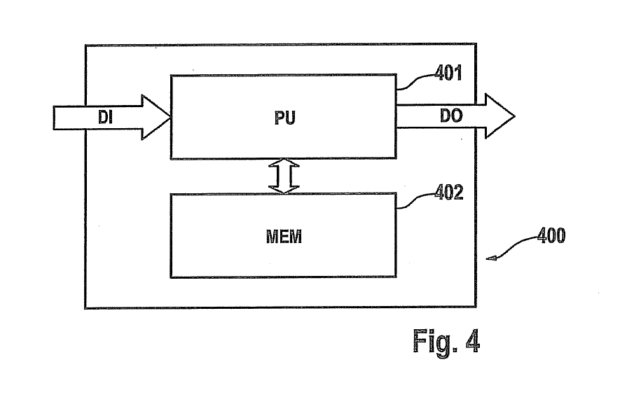

FIG. 4 is a schematic diagram of an alternative, software-based embodiment of the proposed apparatus 400 for ascertaining the working point of valves of a hydraulic system of a vehicle. The proposed apparatus contains a processing unit PU 401 that can be any processor or computer having a control unit, such that the control unit executes control actions based on software routines of a program stored in a memory MEM 402. Program instructions are fetched from memory 402 and loaded into the control unit of processing unit 401 in order to execute the processing steps of the above-described functionalities. These processing steps can be executed on the basis of input data DI and generate output data DO; the input data can correspond to at least one admission pressure and/or one circuit pressure, and the output data DO can correspond to a pressure difference and/or to a signal corresponding to a working point.

A method and an apparatus have been described for ascertaining the working point of switchover valves of a hydraulic system of a vehicle, in particular of a hydraulic brake system, the hydraulic system containing at least a pressure generating arrangement, a high-pressure switching valve, a switchover valve, and an admission pressure sensor; an admission pressure p_adm that is higher than the target pressure of the switchover valve is established; the switchover valve is energized with a target current corresponding to the target pressure; admission pressure p_adm is reduced until the switchover valve closes; with the switchover valve closed, an admission pressure p_adm_nominal is established; after the switchover valve opens, a pressure difference Δp between admission pressure p_adm_nominal and a circuit pressure p_circuit is sensed; and on the basis of pressure difference. Δp, the working point is ascertained.

Be it noted that the proposed solutions corresponding to the aforementioned embodiments can be implemented as software modules and/or hardware modules in the corresponding functional blocks. Be it further noted that the present invention is not limited to the aforementioned embodiments, but can also be applied to other sensor modules.

It is apparent from the foregoing that while exemplifying embodiments have been depicted and described, various modifications can be undertaken without deviating from the basic idea of the invention. The present invention is therefore not to be limited to the exemplifying embodiments by the detailed description thereof.

1-10. (canceled)

11. A method for determining a working point of a switchover valve of a hydraulic system, which includes a brake circuit, of a vehicle, the method comprising:
establishing an admission pressure that is higher than a target pressure of the switchover valve of the hydraulic system, which includes at least a pressure generating arrangement, a high-pressure switching valve, the switchover valve, and an admission pressure sensor;
energizing the switchover valve with a target current I corresponding to the target pressure;
reducing the admission pressure until the switchover valve closes;
establishing, with the switchover valve closed, a nominal admission pressure;
after the switchover valve opens, sensing a pressure difference Δp between the nominal admission pressure and a circuit pressure; and
determining, based on the pressure difference Δp, the working point.

12. The method of claim 11, wherein the admission pressure to be established instead of the nominal admission pressure is determined on the basis of the pressure difference Δp.

13. The method of claim 12, wherein when the pressure difference Δp exceeds a previously set threshold value, the admission pressure is increased.

14. The method of claim 12, wherein when the pressure difference Δp falls below a previously set threshold value, the admission pressure is decreased.

15. The method of claim 11, wherein the target pressure is determined in accordance with an I-dp-q characteristics diagram.

16. The method of claim 11, wherein the reduction in the admission pressure occurs with a constant gradient.

17. The method of claim 11, wherein a nominal characteristics diagram is adapted by the determined admission pressure.

18. An apparatus for determining the working point of a switchover valve of a hydraulic system, including a brake circuit, of a vehicle, comprising:
a pressure generating unit that establishes an admission pressure;
an energizing unit that energizes the switchover valve of the hydraulic system, which includes at least a pressure generating arrangement, a high-pressure switching valve, the switchover valve, and an admission pressure sensor;
a pressure reduction unit that reduces the admission pressure;
a measuring unit that senses a pressure difference Δp between a nominal admission pressure1 and a circuit pressure; and
a calculation unit that determines the working point based on the pressure difference Δp.

19. The apparatus of claim 11, wherein the admission pressure to be established instead of the nominal admission pressure is determined on the basis of the pressure difference Δp.

20. A computer readable medium having a computer program, which is executable by a processor, comprising:
a program code arrangement having program code for determining a working point of a switchover valve of a hydraulic system, which includes a brake circuit, of a vehicle, by performing the following:
establishing an admission pressure that is higher than a target pressure of the switchover valve of the hydraulic system, which includes at least a pressure generating arrangement, a high-pressure switching valve, the switchover valve, and an admission pressure sensor;
energizing the switchover valve with a target current I corresponding to the target pressure;
reducing the admission pressure until the switchover valve closes;
establishing, with the switchover valve closed, a nominal admission pressure;
after the switchover valve opens, sensing a pressure difference Δp between the nominal admission pressure and a circuit pressure; and
determining, based on the pressure difference Δp, the working point.
